(19) United States
(12) Patent Application Publication
(10) Pub. No.: US 2014/0250597 A1
(43) Pub. Date: Sep. 11, 2014

(54) ADJUSTABLE BED FOUNDATION SYSTEM WITH BUILT-IN SELF-TEST

(71) Applicant: Select Comfort Corporation, Minneapolis, MN (US)

(72) Inventors: Yi-ching Chen, Maple Grove, MN (US); John McGuire, New Hope, MN (US); Stacy Stusynski, Blaine, MN (US)

(73) Assignee: Select Comfort Corporation, Minneapolis, MN (US)

(21) Appl. No.: 14/202,996

(22) Filed: Mar. 10, 2014

Related U.S. Application Data
(60) Provisional application No. 61/776,466, filed on Mar. 11, 2013.

(51) Int. Cl. A61G 7/018; G08C 17/02; A47C 27/08

(52) U.S. Cl. CPC A61G 7/018; A47C 27/083; G08C 17/02
USPC 5/600; 340/12.54

(57) ABSTRACT

This disclosure describes built-in self-test techniques for an adjustable bed foundation system. In one example, this disclosure describes a remote controller device for an adjustable bed foundation system, the remote controller device includes a user interface configured to receive input from a user, and a processor configured to initiate, via the user interface, at least one test sequence that tests the remote controller device in response to the received user input, and display, via the user interface, information related to the at least one test sequence.

This application is related to U.S. Provisional Application No. 61/776,466 titled, “ADJUSTABLE BED FOUNDATION SYSTEM WITH BUILT-IN SELFT TEST” to Chen et al. and filed on Mar. 11, 2013, the entire content being incorporated herein by reference in its entirety, and the benefit of priority claimed herein.

### TECHNICAL FIELD

This patent document pertains generally to mattresses and more particularly, but not by way of limitation, to an inflatable air mattress system.

### BACKGROUND

Air bed systems, such as the one described in U.S. Pat. No. 5,904,172 which is incorporated herein by reference in its entirety, generally allow a user to select a desired pressure for each air chamber within the mattress. Upon selecting the desired pressure, a signal is sent to a pump and valve assembly in order to inflate or deflate the air bladders as necessary in order to achieve approximately the desired pressure within the air bladders.

In various examples, an air mattress control system allows a user to adjust the firmness or position of an air mattress bed. The mattress may have more than one zone thereby allowing a left and right side of the mattress to be adjusted to different firmness levels. Additionally, the bed may be adjustable to different positions. For example, the head section of the bed may be raised up while the foot section of the bed stays in place. In various examples, two separate remote controls are used to adjust the position and firmness, respectively.

### BRIEF DESCRIPTION OF DRAWINGS

Some embodiments are illustrated by way of example and not limitation in the figures of the accompanying drawings in which:

FIG. 1 is a diagrammatic representation of an air bed system, according to an example.

FIG. 2 is a block diagram of various components of the air bed system of FIG. 1, according to an example.

FIG. 3 is a block diagram of an air bed system architecture, according to an example.

FIG. 4 is a block diagram of machine in the example form of a computer system within which a set instructions, for causing the machine to perform any one or more of the methodologies discussed herein, may be executed.

FIG. 5 depicts an example functional block diagram of a remote controller device that can implement various techniques of this disclosure.

FIG. 6 depicts an example functional block diagram of a central controller that can implement various techniques of this disclosure.

### DETAILED DESCRIPTION

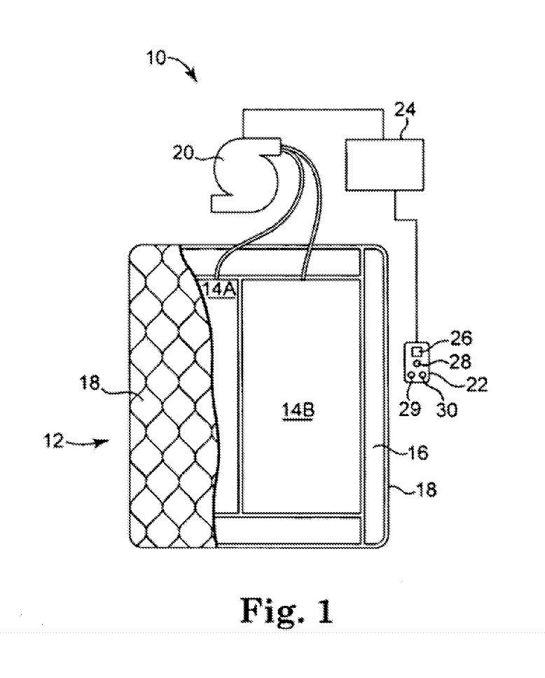

FIG. 1 is a diagrammatic representation of air bed system 10 in an example embodiment. System 10 can include bed 12, which can comprise at least one air chamber 14 surrounded by a resilient border 16 and encapsulated by bed ticking 18. The resilient border 16 can comprise any suitable material, such as foam.

As illustrated in FIG. 1, bed 12 can be a two chamber design having a first air chamber 14A and a second air chamber 14B. First and second air chambers 14A and 14B can be in fluid communication with pump 20. Pump 20 can be in electrical communication with a remote control 22 via control box 24. Remote control 22 can communicate via wired or wireless means with control box 24. Control box 24 can be configured to operate pump 20 to cause increases and decreases in the fluid pressure of first and second air chambers 14A and 14B based upon commands input by a user through remote control 22. Remote control 22 can include display 26, output selecting means 28, pressure increase button 29, and pressure decrease button 30. Output selecting means 28 can allow the user to switch the pump output between the first and second air chambers 14A and 14B, thus enabling control of multiple air chambers with a single remote control 22. For example, output selecting means may by a physical control (e.g., switch or button) or an input control displayed on display 26. Alternatively, separate remote control units can be provided for each air chamber and may each include the ability to control multiple air chambers. Pressure increase and decrease buttons 29 and 30 can allow a user to increase or decrease the pressure, respectively, in the air chamber selected with the output selecting means 28. Adjusting the pressure within the selected air chamber can cause a corresponding adjustment to the firmness of the air chamber.

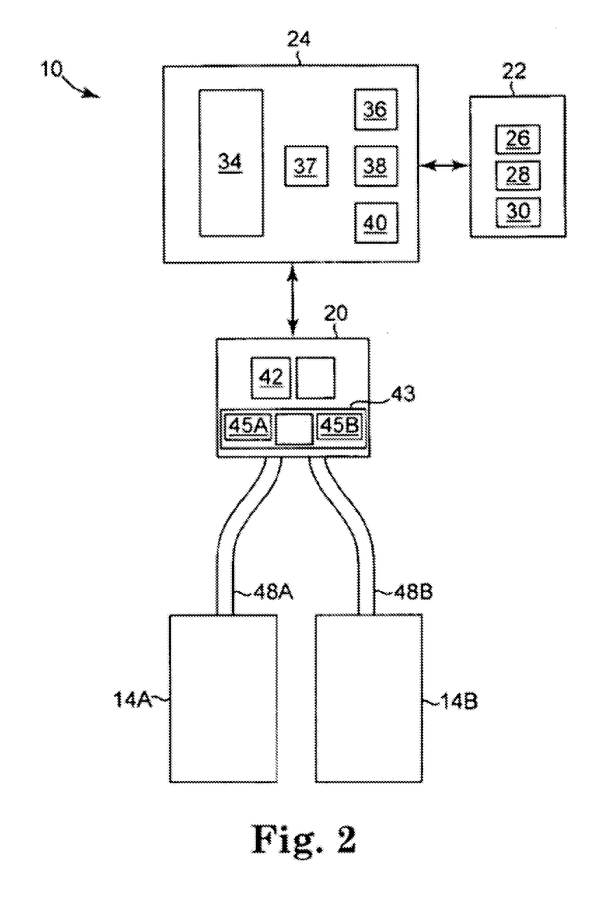

FIG. 2 is a block diagram detailing data communication between certain components of air bed system 10 according to various examples. As shown in FIG. 2, control box 24 can include power supply 34, processor 36, memory 37, switching means 38, and analog to digital (A/D) converter 40. Switching means 38 can be, for example, a relay or a solid state switch. Switching means 38 can be located in the pump 20 rather than the control box 24.

Pump 20 and remote control 22 can be in two-way communication with the control box 24. Pump 20 can include a motor 42, a pump manifold 43, a relief valve 44, a first control valve 45A, a second control valve 45B, and a pressure transducer 46, and can be fluidly connected with the first air chamber 14A and the second air chamber 14B via a first tube 48A and a second tube 48B, respectively. First and second control valves 45A and 45B can be controlled by switching means 38, and can be operable to regulate the flow of fluid between pump 20 and first and second air chambers 14A and 14B, respectively.

In an example, pump 20 and control box 24 can be provided and packaged as a single unit. Alternatively, pump 20 and control box 24 can be provided as physically separate units.

In operation, power supply 34 can receive power, such as 110 VAC power, from an external source and can convert the power to various forms required by certain components of the air bed system 10. Processor 36 can be used to control various logic sequences associated with operation of the air bed system 10, as will be discussed in further detail below.

The example of the air bed system 10 shown in FIG. 2 contemplates two air chambers 14A and 14B and a single pump 20. However, other examples may include an air bed system having two or more air chambers and one or more pumps incorporated into the air bed system to control the air chambers. In an example, a separate pump can be associated with each air chamber of the air bed system or a pump may be associated with multiple chambers of the air bed system. Separate pumps can allow each air chamber to be inflated or deflated independently and simultaneously. Furthermore, additional pressure transducers can also be incorporated into the air bed system such that, for example, a separate pressure transducer can be associated with each air chamber.

In the event that the processor 36 sends a decrease pressure command to one of air chambers 14A or 14B, switching means 38 can be used to convert the low voltage command signals sent by processor 36 to higher operating voltages sufficient to operate relief valve 44 of pump 20 and open control valves 45A or 45B. Opening relief valve 44 can allow air to escape from air chamber 14A or 14B through the respective air tube 48A or 48B. During deflation, pressure transducer 46 can send pressure readings to processor 36 via the A/D converter 40. The A/D converter 40 can receive analog information from pressure transducer 46 and can convert the analog information to digital information useable by processor 36. Processor 36 may send the digital signal to remote control 22 to update display 26 on the remote control in order to convey the pressure information to the user.

In the event that processor 36 sends an increase pressure command, pump motor 42 can be energized, sending air to the designated air chamber through air tube 48A or 48B via electronically operating corresponding valve 45A or 45B. While air is being delivered to the designated air chamber in order to increase the firmness of the chamber, pressure transducer 46 can sense pressure within pump manifold 43. Again, pressure transducer 46 can send pressure readings to processor 36 via A/D converter 40. Processor 36 can use the information received from A/D converter 40 to determine the difference between the actual pressure in air chamber 14A or 14B and the desired pressure. Processor 36 can send the digital signal to remote control 22 to update display 26 on the remote control in order to convey the pressure information to the user.

Generally speaking, during an inflation or deflation process, the pressure sensed within pump manifold 43 provides an approximation of the pressure within the air chamber. An example method of obtaining a pump manifold pressure reading that is substantially equivalent to the actual pressure within an air chamber is to turn off pump 20, allow the pressure within the air chamber 14A or 14B and pump manifold 43 to equalize, and then sense the pressure within pump manifold 43 with pressure transducer 46. Thus, providing a sufficient amount of time to allow the pressures within pump manifold 43 and chamber 14A or 14B to equalize may result in pressure readings that are accurate approximations of the actual pressure within air chamber 14A or 14B. In various examples, the pressure of 48A/B is continuously monitored using multiple pressure sensors.

In an example, another method of obtaining a pump manifold pressure reading that is substantially equivalent to the actual pressure within an air chamber is through the use of a pressure adjustment algorithm. In general, the method can function by approximating the air chamber pressure based upon a mathematical relationship between the air chamber pressure and the pressure measured within pump manifold 43 (during both an inflation cycle and a deflation cycle), thereby eliminating the need to turn off pump 20 in order to obtain a substantially accurate approximation of the air chamber pressure. As a result, a desired pressure setpoint within air chamber 14A or 14B can be achieved without the need for turning pump 20 off to allow the pressures to equalize. The latter method of approximating an air chamber pressure using mathematical relationships between the air chamber pressure and the pump manifold pressure is described in detail in U.S. application Ser. No. 12/936,084, the entirety of which is incorporated herein by reference.

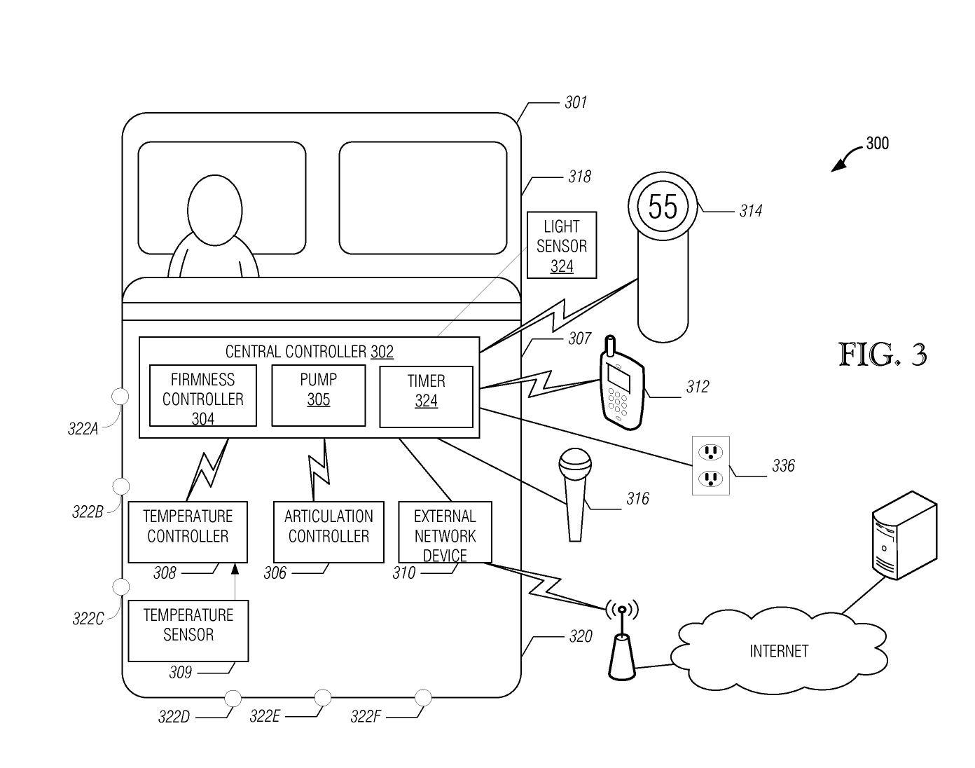

FIG. 3 is illustrates an example air bed system architecture 300. Architecture 300 includes bed 301, e.g., an inflatable air mattress, central controller 302, firmness controller 304, articulation controller 306, temperature controller 308 in communication with one or more temperature sensors 309, external network device 310, remote controllers 312, 314, and voice controller 316. While described as using an air bed, the system architecture may also be used with other types of beds.

As illustrated in FIG. 3, the central controller 302 includes firmness controller 304 and pump 305. The network bed architecture 300 is configured as a star topology with central controller 302 and firmness controller 304 functioning as the hub and articulation controller 306, temperature controller 308, external network device 310, remote controls 312, 314, and voice controller 316 functioning as possible spokes, also referred to herein as components. Thus, in various examples, central controller 302 acts a relay between the various components.

In yet another example, central controller 302 listens to communications (e.g., control signals) between components even if the communication is not being relayed through central controller 302. For example, consider a user sending a command using remote 312 to temperature controller 308. Central controller 302 may listen for the command and check to determine if instructions are stored at central controller 302 to override the command (e.g., it conflicts with a previous setting). Central controller 302 may also log the command for future use (e.g., determining a pattern of user preferences for the components).

In other examples, different topologies may be used. For example, the components and central controller 302 may be configured as a mesh network in which each component may communicate with one or all of the other components directly, bypassing central controller 302. In various examples, a combination of topologies may be used. For example, remote controller 312 may communicate directly to temperature controller 308 but also relay the communication to central controller 302.

In various examples, the controllers and devices illustrated in FIG. 3 may each include a processor, a storage device, and a network interface. The processor may be a general purpose central processing unit (CPU) or application-specific integrated circuit (ASIC). The storage device may include volatile or non-volatile static storage (e.g., Flash memory, RAM, EPROM, etc.). The storage device may store instructions which, when executed by the processor, configure the processor to perform the functionality described herein. For example, a processor of firmness control 304 may be configured to send a command to a relief valve to decrease the pressure in a bed.

In various examples, the network interface of the components may be configured to transmit and receive communications in a variety of wired and wireless protocols. For example, the network interface may be configured to use the 802.11 standards (e.g., 802.11a/b/c/g/n/ac), PAN network standards such as 802.15.4 or Bluetooth, infrared, cellular standards (e.g., 3G/4G etc.), Ethernet, and USB for receiving and transmitting data. The previous list is not intended to exhaustive and other protocols may be used. Not all components of FIG. 3 need to be configured to use the same protocols. For example, remote control 312 may communicate with central controller 302 via Bluetooth while temperature controller 308 and articulation controller 306 are connected to central controller using 802.15.4. Within FIG. 3, the lightning connectors represent wireless connections and the solid lines represent wired connections, however, the connections between the components is not limited to such connections and each connection may be wired or wireless. For example, the voice controller 316 can be connected wirelessly to the central controller 302.

Moreover, in various examples, the processor, storage device, and network interface of a component may be located in different locations than various elements used to effect a command. For example, as in FIG. 1, firmness controller 302 may have a pump that is housed in a separate enclosure than the processor used to control the pump. Similar separation of elements may be employed for the other controllers and devices in FIG. 3.

In various examples, firmness controller 304 is configured to regulate pressure in an air mattress. For example, firmness controller 304 may include a pump such as described with reference to FIG. 2 (see e.g., pump 20). Thus, in an example, firmness controller 304 may respond to commands to increase or decrease pressure in the air mattress. The commands may be received from another component or based on stored application instructions that are part of firmness controller 304.

As illustrated in FIG. 3 central controller 302 includes firmness controller 304. Thus, in an example, the processor of central controller 302 and firmness control 304 may be the same processor. Furthermore, the pump may also be part of central controller 302. Accordingly, central controller 302 may be responsible for pressure regulation as well as other functionality as described in further portions of this disclosure.

In various examples, articulation controller 306 is configured to adjust the position of a bed (e.g., bed 301) by adjusting a foundation 307 that supports the bed. In an example, separate positions may be set for two different beds (e.g., two twin beds placed next to each other). The foundation 307 may include more than one zone, e.g., head portion 318 and foot portion 320, that may be independently adjusted. Articulation controller 306 may also be configured to provide different levels of massage to a person on the bed.

In various examples, temperature controller 308 is configured to increase, decrease, or maintain the temperature of a user. For example, a pad may be placed on top of or be part of the air mattress. Air may be pushed through the pad and vented to cool off a user of the bed. Conversely, the pad may include a heating element that may be used to keep the user warm. In various examples, the pad includes the temperature sensor 309 and temperature controller 308 receives temperature readings from the temperature sensor 309. In other examples, the temperature sensor 309 can be separate from the pad, e.g., part of the air mattress or foundation.

In various examples, additional controllers may communicate with central controller 302. These controllers may include, but are not limited to, illumination controllers for turning on and off light elements placed on and around the bed and outlet controllers for controlling power to one or more power outlets.

In various examples, external network device 310, remote controllers 312, 314 and voice controller 316 may be used to input commands (e.g., from a user or remote system) to control one or more components of architecture 300. The commands may be transmitted from one of the controllers 312, 314, or 316 and received in central controller 302. Central controller 302 may process the command to determine the appropriate component to route the received command. For example, each command sent via one of controllers 312, 314, or 316 may include a header or other metadata that indicates which component the command is for. Central controller 302 may then transmit the command via central controller 302's network interface to the appropriate component.

For example, a user may input a desired temperature for the user's bed into remote control 312. The desired temperature may be encapsulated in a command data structure that includes the temperature as well as identifies temperature controller 308 as the desired component to be controlled. The command data structure may then be transmitted via Bluetooth to central controller 302. In various examples, the command data structure is encrypted before being transmitted. Central controller 302 may parse the command data structure and relay the command to temperature controller 308 using a PAN. Temperature controller 308 may be then configure its elements to increase or decrease the temperature of the pad depending on the temperature originally input into remote control 312.

In various examples, data may be transmitted from a component back to one or more of the remote controls. For example, the current temperature as determined by a sensor element of temperature controller 308, e.g., temperature sensor 309, the pressure of the bed, the current position of the foundation or other information may be transmitted to central controller 302. Central controller 302 may then transmit the received information and transmit it to remote control 312 where it may be displayed to the user.

In various examples, multiple types of devices may be used to input commands to control the components of architecture 300. For example, remote control 312 may be a mobile device such as a smart phone or tablet computer running an application. Other examples of remote control 312 may include a dedicated device for interacting with the components described herein. In various examples, remote controls 312/314 include a display device for displaying an interface to a user. Remote control 312/314 may also include one or more input devices. Input devices may include, but are not limited to, keypads, touchscreen, gesture, motion and voice controls.

Remote control 314 may be a single component remote configured to interact with one component of the mattress architecture. For example, remote control 314 may be configured to accept inputs to increase or decrease the air mattress pressure. Voice controller 316 may be configured to accept voice commands to control one or more components. In various examples, more than one of the remote controls 312/314 and voice controller 316 may be used.

With respect to remote control 312, the application may be configured to pair with one or more central controllers. For each central controller, data may be transmitted to the mobile device that includes a list of components linked with the central controller. For example, consider that remote control 312 is a mobile phone and that the application has been authenticated and paired with central controller 302. Remote control 312 may transmit a discovery request to central controller 302 to inquiry about other components and available services. In response, central controller 302 may transmit a list of services that includes available functions for adjusting the firmness of the bed, position of the bed, and temperature of the bed. In various embodiments, the application may then display functions for increasing/decreasing pressure of the air mattress, adjusting positions of the bed, and adjusting temperature. If components are added/removed to the architecture under control of central controller 302, an updated list may be transmitted to remote control 312 and the interface of the application may be adjusted accordingly.

In various examples, central controller 302 is configured as a distributor of software updates to components in architecture 300. For example, a firmware update for temperature controller 308 may become available. The update may be loaded into a storage device of central controller 302 (e.g., via a USB interface). Central controller 302 may then transmit the update to temperature controller 308 with instructions to update. Temperature controller 308 may attempt to install the update. A status message may be transmitted from temperature controller 308 to central controller 302 indicating the success or failure of the update.

In various examples, central controller 302 is configured to analyze data collected by a pressure transducer (e.g., transducer 46 with respect to FIG. 2) to determine various states of a person lying on the bed. For example, central controller 302 may determine the heart rate or respiration rate of a person lying in the bed. Additional processing may be done using the collected data to determine a possible sleep state of the person. For example, central controller 302 may determine when a person falls asleep and, while asleep, the various sleep states of the person.

In various examples, external network device 310 includes a network interface to interact with an external server for processing and storage of data related to components in architecture 300. For example, the determined sleep data as described above may be transmitted via a network (e.g., the Internet) from central controller 302 to external network device 310 for storage. In an example, the pressure transducer data may be transmitted to the external server for additional analysis. The external network device 310 may also analyze and filter the data before transmitting it to the external server.

In an example, diagnostic data of the components may also be routed to external network device 310 for storage and diagnosis on the external server. For example, if temperature controller 308 detects an abnormal temperature reading (e.g., a drop in temperature over one minute that exceeds a set threshold) diagnostic data (sensor readings, current settings, etc.) may be wireless transmitted from temperature controller 308 to central controller 302. Central controller 302 may then transmit this data via USB to external network device 310. External device 310 may wirelessly transmit the information to an WLAN access point where it is routed to the external server for analysis.

In one example, the bed system 300 can include one or more lights 322A-322F (referred to collectively in this disclosure as “lights 322”) to illuminate a portion of a room, e.g., when a user gets out of the bed 301. The lights 322 can be attached around the foundation 307, e.g., affixed to the foundation around its perimeter. In FIG. 3, the lights 322 are depicted as extending around two sides of the foundation 307. In other configurations, the lights 322 can extend around more than two sides of the foundation 307, or only a single side. In one example implementation, the lights 322 can be positioned underneath the foundation 307 to project light outwardly from the foundation 307.

### Example Machine Architecture and Machine-Readable Medium

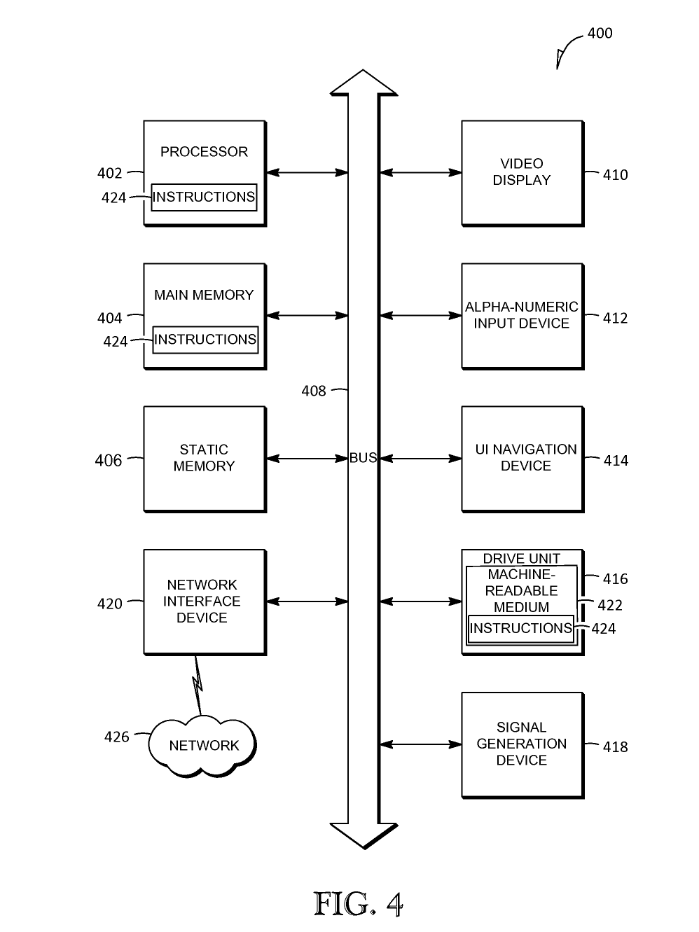

FIG. 4 is a block diagram of machine in the example form of a computer system 400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU), ASIC or a combination), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard and/or touchscreen), a user interface (UI) navigation device 414 (e.g., a mouse), a disk drive unit 416, a signal generation device 418 (e.g., a speaker) and a network interface device 420.

### Machine-Readable Medium

The disk drive unit 416 includes a machine-readable medium 422 on which is stored one or more sets of instructions and data structures (e.g., software) 424 embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Built-in Self-Test Techniques

In addition to the techniques described above, this disclosure is directed to built-in self-test (also referred to as “BIST” in this disclosure) techniques for an adjustable bed foundation system, such as air bed system architecture 300 of FIG. 3. As described in more detail below, in one example implementation, a remote controller device, e.g., either or both of remote controllers 312, 314, that is configured to remotely control the system 300 can enter a self-test mode and test various aspects of the remote controller device. In addition, the system 300 can run a BIST, transmit information related to the BIST to the remote controller device, e.g., remote controllers 312, 314, and then the remote controller device can display information related to the system BIST. In this manner, the techniques of this disclosure can provide a simple and convenient way for a technician, for example, to diagnose any issues with the remote controller device and/or the system 300.

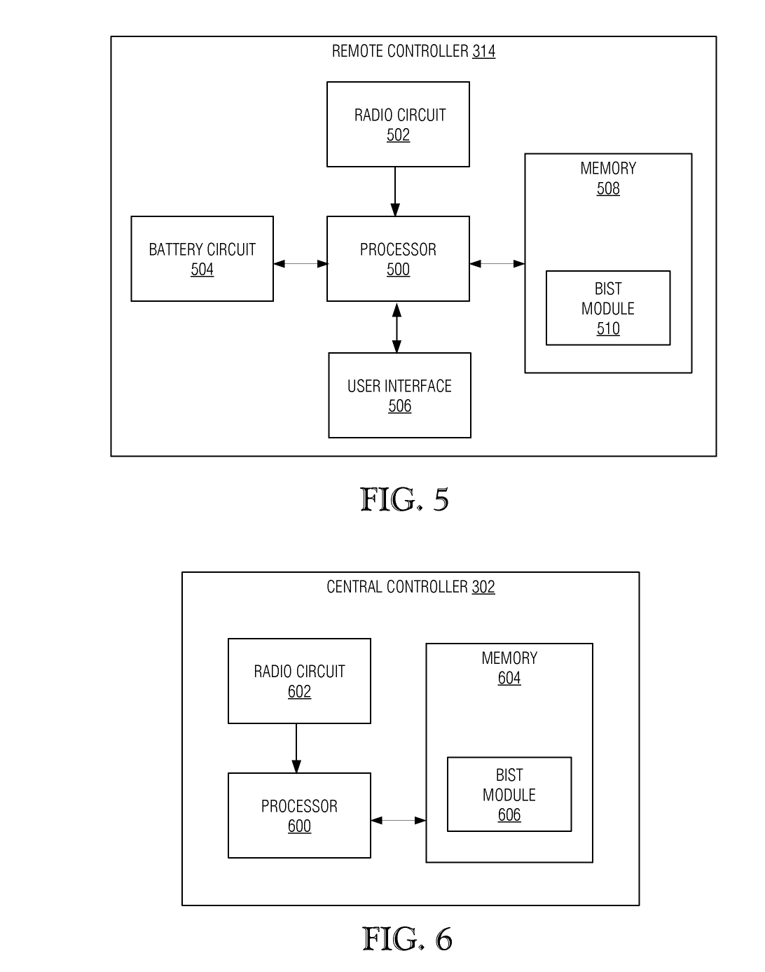

FIG. 5 depicts an example functional block diagram of a remote controller device that can implement various techniques of this disclosure. The remote controller device 314 of FIG. 5 can include a processor 500, a radio circuit 502, a battery circuit 504, a user interface 506 configured to receive input from a user, and a memory device 508 that can include a BIST module 510 that includes instructions for executing one or more BIST test techniques.

The user interface 506 can include a display and two or more buttons for controlling various aspects of the bed system 300, e.g., adjusting the head portion 318 or the foot portion 320 of FIG. 3 and a massage function. In some examples, the user interface 506 can include a touchscreen. In such examples, the touchscreen display can display two or more buttons for controlling various aspects of the bed system 300.

In one example implementation, upon receiving user input via the user interface 504, the remote controller device 314 can execute a BIST on itself. More particularly, upon receiving user input via the user interface 506, the processor 500 of the remote controller device 314 can execute instructions stored in the BIST module 510 of the memory device 508 that can run one or more built-in self-tests.

A user may, for example, press one or more specific button combinations that can initiate one or more built-in self-tests. For example, a first button combination can initiate at least one test sequence that tests the radio circuit 502. The radio circuit 502 can include transmit and receive circuitry for communicating with the central controller 302 of FIG. 3. In one example, the radio circuit 502 can include Bluetooth circuitry for communicating with the central controller 302. The BIST can, for example, test the radio circuit 502 to ensure that either or both of the transmit and receive circuitry is operating correctly.

As another example, a second button combination can initiate at least one test sequence that tests the battery circuit 504. The battery circuit 504 can include a low battery level circuit and a battery charger circuit, for example. Upon receiving the second button combination, the BIST of the battery circuit 504 can test the low battery circuit and/or the battery charger circuit to determine if they are operating correctly.

In some examples, a third button combination can initiate at least one test sequence that tests both the radio circuit 502 and the battery circuit 504. Although this disclosure describes testing the radio circuit 502 and the battery circuit 504, this disclosure is not limited to performing a BIST on these two circuits. There may be additional or alternative circuitry within the remote controller 314 for which a BIST can be performed.

Upon completing the BIST of one or more aspects of the remote controller 314, the remote controller 314 can display on the user interface information related to the at least one test sequence. For example, the user interface can display an error code, e.g., a numerical error code, that corresponds to the particular error condition detected using the BIST. A user or technician can look up the error code, e.g., on a table, and determine the corresponding error condition. In another example, the user interface can display text that is descriptive of the error condition, e.g., “LOW BATTERY LEVEL” or “BATT NOT CHARGING”)

In addition to performing built-in self-tests on itself, the remote controller 314 can receive information related to one or more error conditions of the system 300. For example, as described in more detail below with respect to FIG. 6, the central controller 302 can initiate a BIST of various components of the system 300 and transmit the results to the remote controller 314.

FIG. 6 depicts an example functional block diagram of the central controller 302 that can implement various techniques of this disclosure. The central controller 302 can include processor 600, a radio circuit 602, and a memory device 604 that can include a BIST module 606 for executing one or more BIST test techniques.

The radio circuit 602 can include transmit and receive circuitry to allow communication with the remote controller device 314, for example. In one example implementation, the processor 600 of the central controller 302 can execute at least one BIST test sequence, via the processor 600 and the BIST module 606, on one or more components of the system 300, e.g., motor 46 of FIG. 2. Upon completion of the BIST, the radio circuit 602 of the central controller 302 can transmit information related to the at least one test sequence to the remote controller device 314. For example, the radio circuit 602 can transmit an error code to the remote controller device 314 based on the error condition determined as a result of the BIST.

As one specific example, the BIST can determine an error condition related to the motor 46 (of FIG. 2), e.g., the motor 46 is drawing too much current. Then, the radio circuit 602 of the central controller 302 can transmit information related to the error condition, e.g., an error code, to the remote controller 314 for display on the user interface 506 (of FIG. 5). As another specific example, the BIST can determine an error condition related to the control box 24 (of FIG. 2), e.g., the control box 24 is disconnected and/or the control box is not receiving power. As another specific example, the BIST can determine an error condition related to the power supply 34 (of FIG. 2), e.g., a voltage rail of the power supply 34 is below a specified threshold.

In some example implementations, the central controller 302 can automatically initiate one or more BIST test sequences of the system 300, e.g., using schedules. In other example implementations, the user can initiate one or more BIST test sequences of the system 300 using the user interface 506 by pressing specified combinations of buttons.

In addition, the remote controller device 314 can initiate at least one test sequence that tests the connection between the remote controller device 314 and the central controller 302. If the radio circuit 602 of the central controller 600 is not functioning properly, then the remote controller device 314 can display, via the user interface 506, information related to a communication error between the remote controller device 314 and the central controller 302 of the adjustable bed foundation system 300.

The BIST test techniques of this disclosure were described with respect to remote controller 314, e.g., a dedicated device for interacting with the components described in this disclosure. In other example implementations, the remote controller device can be a mobile device, such as a smart phone or tablet computer running an application, e.g., remote controller 312.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. As it common, the terms “a” and “an” may refer to one or more unless otherwise indicated.

1. A remote controller device for an adjustable bed foundation system, the remote controller device comprising:
a user interface configured to receive input from a user; and
a processor configured to:
initiate, via the user interface, at least one test sequence that tests the remote controller device in response to the received user input; and
display, via the user interface, information related to the at least one test sequence.

2. The remote controller device of claim 1, further comprising:
at least one radio circuit, wherein the at least one test sequence tests the at least one radio circuit.

3. The remote controller device of claim 2, wherein the at least one radio circuit comprises a Bluetooth radio circuit.

4. The remote controller device of claim 1, further comprising:
at least one battery circuit, wherein the at least one test sequence tests the at least one battery circuit.

5. The remote controller device of claim 1, wherein the user interface comprises a plurality of buttons, and wherein the received user input comprises a specified combination of at least two of the plurality of buttons.

6. The remote controller device of claim 1, wherein the user interface comprises a touchscreen.

7. The remote controller device of claim 1, wherein the information related to the at least one test sequence comprises an error code.

8. The remote controller device of claim 1, wherein the processor is further configured to:
receive, via a central controller of the adjustable bed foundation system, an error code related to the adjustable bed foundation system; and
display, via the user interface, the received error code.

9. The remote controller device of claim 8, wherein the received error code related to the adjustable bed foundation system is related to a motor of the adjustable bed foundation system.

10. The remote controller device of claim 1, wherein the processor is further configured to:
display, via the user interface, information related to a communication error between the remote controller device and a central controller of the adjustable bed foundation system.

11. An adjustable bed foundation system comprising:
an inflatable air mattress;
an adjustable foundation;
a central controller comprising:
a pump; and
a first processor configured to control one or more aspects of the adjustable bed foundation system;
a remote controller device configured to remotely control, via the central controller, the one or more aspects of the adjustable bed foundation system, the remote controller device comprising:
a user interface configured to receive input from a user; and
a second processor configured to:
initiate, via the user interface, at least one test sequence that tests the remote controller device in response to the received user input; and
display, via the user interface, information related to the at least one test sequence.

12. The system of claim 11, wherein the remote controller device further comprises:
at least one radio circuit, wherein the at least one test sequence tests the at least one radio circuit.

13. The system of claim 12, wherein the at least one radio circuit comprises a Bluetooth radio circuit.

14. The system of claim 11, wherein the remote controller device further comprises:
at least one battery circuit, wherein the at least one test sequence tests the at least one battery circuit.

15. The system of claim 11, wherein the user interface comprises a plurality of buttons, and wherein the received user input comprises a specified combination of at least two of the plurality of buttons.

16. The system of claim 11, wherein the user interface comprises a touchscreen.

17. The system of claim 11, wherein the information related to the at least one test sequence comprises an error code.

18. The system of claim 11, wherein the second processor is further configured to:
receive, via the central controller, an error code related to the adjustable bed foundation system; and
display, via the user interface, the received error code.

19. The system of claim 18, wherein the adjustable bed foundation system further comprises:
a motor,
wherein the received error code related to the adjustable bed foundation system is related to the motor.

20. The system of claim 11, wherein the second processor is further configured to:
display, via the user interface, information related to a communication error between the remote controller device and the central controller.
